(19) United States
(12) Patent Application Publication
(10) Pub. No.: US 2004/0051211 A1
(43) Pub. Date: Mar. 18, 2004

(54) Production of seamless belts and seamless belt products

(75) Inventors: Paul F. Mastro, Little Rock, AR (US); Douglas W. Angold, Rochester, NY (US); Ken M. Cerrah, Webster, NY (US)

Correspondence Address: ANTHONY H. HANDAL, KIRKPATRICK & LOCKHART, LLP, 599 LEXINGTON AVENUE, 31ST FLOOR, NEW YORK, NY, 10022-6030, US

(73) Assignee: Xerox Corporation

(21) Appl. No.: 10/242,561

(22) Filed: Sep. 12, 2002

(51) Int. Cl. B29C 41/08

(52) U.S. Cl. 264/438; 264/309; 264/310; 425/174.8 E; 425/435

(57) ABSTRACT

Disclosed is an inventive process for the manufacture of polymeric seamless belts, e.g. drive, fuser or toner belts for reprographics applications. The novel seamless belts can have a smooth outer surface the dimensions and quality of which are effectively determined by the inner surface of a hollow mandrel employed as a mold during manufacture. The mandrel inner surface can be highly polished to enhance the smoothness of the belt outer surface, and can be formed of a material with a lower coefficient of thermal expansion than the belt polymer to facilitate removal of the belt from the mandrel after curing. The molded belt can be used “as is”, be sliced into smaller belts or be employed as a substrate for deposition of additional belt layers and then, optionally, sliced. The polymer, e.g. a polyimide, can be deposited on the mandrel inner surface by electrostatic powder spraying employing an inventive apparatus employing a rotating mandrel and a powder spray gun reciprocable along the rotating mandrel axis. Electrostatic powder spraying is advantageous in avoiding use of volatile organic solvents and providing an environmentally friendly process.

### FIELD OF THE INVENTION

The present invention relates to processes for producing continuous or endless seamless belts from a polymeric material. The invention also relates to novel seamless belts produced by the inventive processes and to apparatus for carrying out such processes. The invention furthermore relates to the production of seamless belts for use in the xerographic, reprographic and other industries, for example in the printing, copying, and duplicating industries.

### BACKGROUND

The xerographic, reprographic and other industries have many applications for single and multilayer flexible endless belts, which may be employed as drive belts, document handlers, transfer belts, fuser belts, toner belts, photoreceptor belts, and in other ways as is known to those skilled in the art.

The art contains many disclosures of endless seamed belts with various seam configurations and of methods of making such belts. For example, Kitagawa et al. in U.S. Pat. No. 5,421,450 disclose a butt-jointed, endless, heat-resistant laminated conveyor belt comprising reinforcing and wear-resistant layers and a method of making same. Sharf et al. in U.S. Pat. No. 5,487,707 disclose a puzzle cut seamed belt with bonding between adjacent surfaces by UV cured adhesive. Schlueter, Jr. et al. in U.S. Pat. No. 5,514,436 discloses an endless puzzle cut flexible seamed belt having a mechanically invisible seam and substantially equivalent performance to a seamless belt which can essentially function as an endless belt having a substantially uniform thickness, according to the abstract.

Also, in U.S. Pat. No. 5,549,193, Schlueter, Jr. et al. disclose an endless flexible seamed belt having at least one overlapping butting interlocking joint which has a substantially reduced height differential between the seam and the unseamed portions of the belt. Furthermore, in U.S. Pat. No. 5,670,230, Schlueter, Jr. et al. disclose an endless flexible seamed belt having at least one overlapping butting joint and substantially no height differential between the seam and adjacent belt portions.

While the disclosures of the foregoing patents are believed suitable for their intended purposes, as is known in the art, seamless belts generally have one or more properties that render them attractive for certain applications. For example, seamed document handler belts tend to accumulate dirt in the seam area, necessitating frequent cleaning. In addition, seamed photoreceptor belts may require control hardware to sense or track the seam to ensure that it does not appear in an exposure area and mar copy quality. This requirement can be eliminated by employing seamless belts. Also, in some cases, a seamed belt may require a dead cycle to locate a timing hole in the belt and index the seam. This dead cycle is not required for seamless photoreceptor belts. Furthermore, some charging, cleaning and vibration problems in photocopiers may relate to interactions between the seam of some seamed belts and the photocopier machine's subsystems. Still further, by employing a seamless belt, image positioning can advantageously be randomized around the belt to extend belt life; which is not possible with a seamed belt. Moreover, using a seamless photoreceptor belt enables composite copies of various sizes to be produced by sequential passes of the belt.

Accordingly, various processes and apparatus have been proposed for manufacturing seamless belts.

For example, McAneney et al. U.S. Pat. No. 4,711,833 (“McAneney et al.” hereinafter) discloses a process for fabrication of seamless substrates, for example seamless belts comprising electrostatic powder spraying of polymer particles on a substrate such as a mandrel, melting and cooling the polymer, for example by water quenching, and separating the resulting seamless belt or the like from the mandrel or other substrate. Separation can be accomplished, according to one embodiment, by employing a hollow aluminum mandrel (FIG. 1) having removable plugs at both ends, removing the plugs removed from inside the mandrel, capping the mandrel at both ends and applying air pressure to lift and release the belt from the mandrel surface (column 10, lines 30-40). The entire disclosure of McAneney et al. is hereby incorporated herein by reference thereto, as though fully set out herein.

Miyamoto et al. in U.S. Pat. No. 6,001,440 (“Miyamoto et al.” hereinafter) discloses forming of a belt material on the inner surface of a drum by centrifugal casting, using a centrifugal casting machine, of a heat-conductive powder-containing poly(amic acid) solution adjusted to a desired viscosity. A disclosed casting machine comprises a rotating drum provided with heating and rotating means. The inner surface of the drum is mirror-finished and has ring frames with an adequate height provided on both inner peripheral edges of the drum.

In addition Miyamoto et al. disclose formation of a multi-layer belt comprising a fluororesin film layer formed on the outer surface polyimide film. The fluororesin film layer is intended to improve the releasability of a toner image acceptor, e.g. paper, carton, overhead projector sheets, from the heat-conductive polyimide film.

Agur et al. in U.S. Pat. No. 5,128,091 (“Agur et al. '091” hereinafter) and U.S. Pat. No. 6,106,762, (“Agur et al. '762” hereinafter) disclose a stretch blow-molding process for forming biaxially oriented polymeric seamless belts and imaging members wherein fluid under pressure is introduced into a heated polymeric preform to expand the preform into a mold. The entire disclosures of each of Agur et al. '091 and Agur et al. '762 are hereby incorporated herein by reference thereto, as though fully set out herein.

The foregoing description of background art may include insights, discoveries, understandings or disclosures, or associations together of disclosures, that were not known to the relevant art prior to the present invention but which were provided by the invention. Some such contributions of the invention may have been specifically pointed out herein, whereas other such contributions of the invention will be apparent from their context.

### SUMMARY

The present invention provides a method of manufacturing an endless seamless belt having a smooth outer surface with precisely controlled dimensions and surface quality.

The invention also provides a method of manufacturing seamless belts with controlled outer surface quality and dimensions and that are particularly well suited to operation as durable, precision components of reprographic, xerographic and other equipment.

Furthermore, the invention provides a method of manufacturing a seamless belt with a molded outer surface and good uniformity of thickness both longitudinally, and around the belt.

Still further the invention provides a method of manufacturing a seamless belt that can be cured at a relatively high temperature while mounted on a mandrel or other mold and removed from the mandrel when cooled without significant loss of belt quality.

The invention also provides a seamless belt manufacturing method and apparatus which can be carried out and operated in an environmentally desirable manner.

In one aspect the invention provides, a process for manufacturing an endless seamless belt from a polymeric material—comprising:

a) spraying a fusible polymeric powder from a powder source onto the inner surface of a hollow mandrel, the mandrel inner surface providing a cylindrical form for the seamless belt and the form being covered with sprayed powder;

b) curing the powder deposited on the mandrel at an elevated temperature to fuse the powder and form the seamless belt; and

c) removing the seamless belt from the mandrel.

In one embodiment of the inventive process, the powder spraying is conducted electrostatically by employing a polymeric powder suitable for electrostatic spraying and by generating an electrical field, optionally of from about 30,000 to about 50,000 volts, between the powder source and the mandrel to guide the sprayed powder from the mandrel source to the mandrel.

A further embodiment of the inventive process comprises cooling the mandrel and seamless belt after curing and before removing the seamless belt from the mandrel. Pursuant to the invention, the mandrel can advantageously be formed of a material selected to have a first coefficient of thermal expansion while the polymer is selected to have a second coefficient of thermal expansion, the second coefficient of thermal expansion being greater than the first coefficient of thermal expansion, optionally at least two times greater, to permit the seamless belt to shrink from the mandrel during cooling. Such shrinkage of the formed belt during cooling can facilitate removal of the belt from the mandrel.

By means of the inventive process seamless belts can be manufactured with a smooth outer surface of controlled dimensions which is effectively molded from the inner surface of the mandrel and can reflect the quality of the mandrel inner surface. Furthermore, electrostatic powder spraying is advantageous in avoiding volatile organic solvents and providing an environmentally friendly process. Excess sprayed powder can be contained and collected by employing one or more spray or powder booths.

In another aspect, the invention provides a process for manufacturing an endless seamless belt from a polymeric material. The process employs a hollow mandrel formed of a material having a coefficient of thermal expansion selected to be less than the coefficient of thermal expansion of the polymeric material to permit the seamless belt to shrink from the mandrel during cooling. The mandrel has an inner surface providing a form for the seamless belt, the form optionally being cylindrical. The method comprises:

a) depositing a heat curable polymer material in a flowable state onto the inner surface of the hollow mandrel to cover the form with polymer material;

b) curing the deposited polymer on the mandrel at an elevated temperature to form the seamless belt;

c) cooling the mandrel and seamless belt after curing and before removing the seamless belt from the mandrel; and

d) removing the seamless belt from the mandrel.

In a further aspect, the invention provides an endless, seamless belt manufactured by the process of the invention.

In a still further aspect, the invention provides apparatus for manufacturing an endless seamless belt from a fusible polymeric material. The apparatus comprises:

a) a hollow mandrel having an inner surface providing a cylindrical form for the seamless belt, the mandrel being rotatable about an axis; and

b) a powder spray gun reciprocally movable relatively to the hollow mandrel in the direction of the mandrel axis for spraying the polymeric powder onto the inner surface of the hollow mandrel.

A suitable mandrel is a thin cylindrical sleeve having a coefficient of thermal expansion substantially less than that of the polymeric powder. The spray gun can be electrostatic to guide powder to the mandrel inner surface.

### BRIEF DESCRIPTION OF THE DRAWINGS

Some embodiments of the invention, and of making and using the invention, as well as the best mode contemplated of carrying out the invention, if not described above, are described in detail below, by way of example, with reference to the accompanying drawings, in which like reference characters designate the same or similar elements throughout the several views, and in which:

FIG. 1 is a schematic view illustrating a first and optional step of a seamless belt manufacturing process according to the invention wherein a release coating is applied to the inside surface of a hollow mandrel;

FIG. 2 is a view similar to FIG. 1 illustrating a second step comprising applying a powdered polymer to the inside surface of the mandrel;

FIG. 3 is a view similar to FIG. 1 illustrating a third step comprising curing the powdered polymer on the mandrel;

FIG. 4 is a view similar to FIG. 1 illustrating a fourth step comprising removing the cured seamless belt from the mandrel;

FIG. 5 is a largely schematic side elevational view of a powder spraying apparatus according to the invention for use in applying powder by the method illustrated in FIG. 2;

FIG. 6 is a view on the line 6-6 of FIG. 5;

FIG. 7 is a side elevational view of alternative spray gun deflectors for use in the apparatus shown in FIG. 5;

FIG. 8 is an side cross-sectional view similar to FIG. 5 showing an alternative means of mounting a hollow mandrel for powder spraying;

FIG. 9 is a view similar to FIG. 5 of an alternative arrangement for mounting a modified hollow mandrel for internal powder spraying; and

FIG. 10 is an end view of the hollow mandrel of FIG. 9 showing an optional support structure for the free end of the mandrel, which structure is not present in FIG. 9.

### PREFERRED EMBODIMENTS OF THE INVENTION

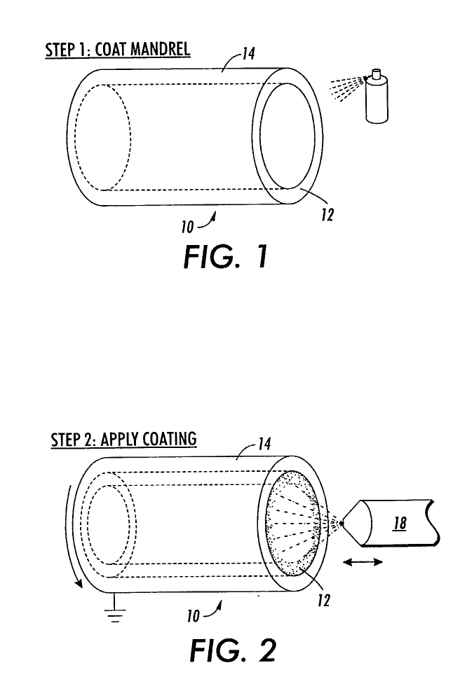

Referring now to FIGS. 1-4 of the drawings, the inventive seamless belt manufacturing process illustrated employs a thin hollow mandrel 10 provided with a right cylindrical interior surface 12 having a powder receiving length and a diameter dimensioned according to the desired outer dimensions of the seamless belt to be manufactured. Inner surface 12 of mandrel 10 can have one, some or all of the qualities of being smooth, continuous, uninterrupted geometrically, and dimensionally precise and free of irregularities, to provide a seamless belt whose outer surface has similar qualities. The whole interior surface of mandrel 10 that receives powder coating can comprise a form or mold for the end product belt.

As shown in FIGS. 1-4, the whole of mandrel interior surface 12 is coated with a suitable polymer powder and thus comprises a form or mold for the seamless belt. However, it will be understood that a selected portion or portions of interior surface 12 may be coated with polymer to provide different results. For example, the powder may be deposited on less than the entire length of the belt to provide a belt which is shorter than mandrel 10. Alternatively, multiple longitudinal sections of interior surface 12 may be coated with polymer particles to provide multiple belts of the same or different sizes. The belts may be demarcated, one from the other, by polymer-free bands around interior surface 12 or by separators such as circumferential rings upstanding from interior surface 12, or by other suitable structure. A further alternative is to apply an incomplete pattern of polymer to interior surface 12 to provide other shapes for a belt or other article, for example, a helical belt or an open-ended, C-shaped member, or, if the polymer lacks memory, a flat open-ended sheet.

Powder-receiving inner surface 12 is finished and polished to a suitable degree according to the desired surface quality of the seamless belt to be made. To this end, inner surface 12 can be polished to a roughness of no greater than 2 microns. If desired, polishing may be to a roughness no greater than 1 micron or even to a roughness of no greater than sub-micron, for example to a roughness of no greater than about 0.5 micron.

Mandrel 10 can be formed of any suitable material however, pursuant to the invention, the mandrel can have a relatively low coefficient of thermal expansion, sometimes referred to as the “a value” hereinafter, relative to the a value of the belt material, to facilitate removal of the belt after curing. After the polymer coating on mandrel 10 has been fused and cured in an oven, while still on mandrel 10, which steps are described in more detail hereinbelow, the polymer coating and mandrel 10 are cooled. During cooling, at about the glass transition temperature of the polymer, the polymer coating assumes the shape and dimensions of the inner surface 12 of mandrel 10, thus forming a belt. By using a mandrel material selected to have an a value lower, if desired, significantly lower, than the a value of the polymer, the belt is caused to shrink more than mandrel 10, for example, during further cooling to room or another desired temperature, facilitating release of the belt from mandrel 10. If the a value of the mandrel material is higher than that of the polymer, mandrel 10 will compress, and perhaps deform, the belt during cooling, impeding removal of the seamless belt from mandrel 10.

One suitable mandrel material, having a relatively low coefficient of thermal is stainless steel. Other suitable materials are described hereinbelow.

Mandrel 10 can be of unitary, one-piece, monolithic construction, that it have a constant cross-sectional configuration throughout its material-receiving length and have an outer surface 14 which is also a right cylinder. Furthermore, mandrel 10 can be thin-walled to enhance heat distribution to the polymer material coating the inside of mandrel 10 during curing. Thus mandrel 10 can comprise a thin, right-cylindrical sleeve having a wall thickness of not more than about 3 mm, if desired, not more than about 1 mm. In one particular embodiment of the invention, the wall thickness is from about 0.2 to about 0.7 mm, for example about 0.4 mm (about 0.015 in).

Some other possible mandrel constructions, pursuant to the invention, are described hereinbelow and still others are possible, as will be apparent to those skilled in the art in light of this disclosure.

Step 1, illustrated in FIG. 1 is an optional step in the process wherein a release coating is applied to the inside of mandrel 10 to help separate the formed seamless belt from mandrel 10. A suitable release coating, for example a silicone oil, fine talc powder, graphite powder or the like can be hand sprayed from a can or applied by other suitable means to polished inner surface 12. If there is sufficient lack of adhesion between the mandrel and the formed belt, and a sufficient difference in a value, or other factors to permit satisfactory release of the belt from the mandrel, a release coating may not be necessary.

In Step 2, as illustrated in FIG. 2, mandrel 10, coated with release agent, if used, is mounted on a rotatable support in a powder booth that enables excess sprayed powder to be contained and retrieved. In one inventive apparatus for performing the illustrated process, an electrostatic powder spray gun 16 is employed to apply a coating of a suitable powdered thermosetting or thermoplastic polymeric material to the inner surface 12 of mandrel 10. One suitable polymer is a polyimide, for example a polyaryletheretherketone. If desired, a fine powder can be employed, for example a powder at least 95 percent of the particles of which are less than 200 micron in size, as is known for electrostatic powder spraying.

Spray gun 16 can be mounted as a cantilever for reciprocal travel along the longitudinal axis of hollow mandrel 10 and has a tubular nozzle 18 extending into mandrel 10 with a distal tip (not shown) of nozzle 18 disposed within mandrel 10 for most if not all of the travel of spray gun 16.

Spray gun 16 can be supported for reciprocal movement by any suitable structure, as known to those skilled in the art, for example on a spray gun carriage such as that described hereinbelow. Alternatively, hollow mandrel 10 could be arranged to be reciprocably movable with respect to the spray gun.

Mandrel 10 is rotated at a suitable angular velocity to facilitate uniform coverage of inner surface 12 with polymer powder, especially in a circumferential sense. Suitable speeds can be determined by experiment without undue difficulty in a particular case and can for example be at from about 20 to about 500 rpm, if desired, from about 100 to about 200 rpm.

Spray gun 16 travels at a longitudinal velocity which is related to the thickness of the powder layer to be deposited and to the spray gun and powder characteristics having due regard to each manufacturer's recommendations. The number of passes is determined by the desired thickness of the finished belt and may be, for example, one or more passes, perhaps three passes.

To help transfer powder particles from spray gun 16 to the target location, namely inner surface 12 of mandrel 10, and reduce overspray, an electrostatic field can be generated between spray gun 16 and mandrel 10 whereby the powder particles will tend to follow the field lines. For this purpose, mandrel 10 is grounded and spray gun 16 is maintained at a suitable electrostatic voltage, according to the material being sprayed, as specified by the relevant manufacturer, or as is known in the art. The voltage may for example be from about 30,000 to about 50,000 volts and is effective when spray nozzle 16 is within about 10 cm from inner surface 12 of mandrel 10. Higher voltages can be employed for larger diameter mandrels employed for larger diameter belts.

Spray gun 16 discharges from nozzle 18 a cone-shaped spray of particles of the polymer material with which it is loaded from nozzle 18. As spray gun 16 moves longitudinally back and forth, within mandrel 10, the inside surface of mandrel 10 is covered with as many powder coatings as are desired. It will be appreciated that the discharge orifice (not shown) of nozzle 18 moves entirely or substantially entirely within mandrel 10 while spraying, with the possible exception, in some cases, that at the commencement of travel, the orifice might be outside the mandrel, to allow for the forward projection of the powder.

To facilitate uniform coverage, spray gun 16 is moved on the gun carriage at a generally constant velocity throughout the extent of travel required to spray inner surface 12 of mandrel 10. If desired, to coat inner surface 12 uniformly throughout the whole length of mandrel 10, the forward and return travels of spray gun 16 can overlap each end of mandrel 10 by a short distance. Spraying can be conducted in a manner that will deposit on inner surface 12 of mandrel 10 a powder coating which is continuous and has a uniform thickness throughout its extent being free of voids, gaps and surplus accumulations of powder.

Spraying is carried out for one or more passes until the desired deposit thickness is achieved. The number of passes required can be estimated empirically from the known discharge rate and speed of travel of the spray gun, taking into account the inside diameter of mandrel 10 and using an approximate powder transfer efficiency for example an efficiency in the range of about 45 to 70 percent, such as about 50 percent. The thickness per pass can then readily be determined experimentally for a particular configuration.

Deflectors, further described hereinbelow, may be used to reach into the far end of mandrel 10. Also, when employing a larger diameter mandrel 10 to make larger diameters belts, an array of multiple spray guns, for example three spray guns, generating overlapping patterns, may be used.

Spraying the powder onto the mandrel interior surface has the advantage that the mandrel itself helps shroud and contain the spray, reducing overspray and facilitating collection of extraneous sprayed powder. The use of an electrostatic field to guide the sprayed powder, results in a uniquely effective control of the polymer powder discharged from nozzle 18. If desired, the end of mandrel 10 remote from spray gun 16 can be provided with a closing cap to prevent powder from emerging, which cap may extend sufficiently beyond the form area to prevent bounce-back adversely affecting uniformity of coverage.

Desirably, the application of the electrostatic field provides a spray or stream of electrically charged polymer powder particles which are attracted to the metallic mandrel inner surface 12. Electrostatic attraction, or other prevailing physical force or forces, can hold the powder in place on the rotating mandrel inner surface 12.

To avoid displacement of the deposited powder, it is desirable to limit air movement, for example air currents originating from the compressed air source employed for spraying, near the powder-coated mandrel, e.g to a maximum air velocity of 100 feet per second. Desirably also, care is taken to avoid physically impacting, shocking or jarring the powder-coated mandrel to prevent dislodgement of powder particles.

In another embodiment of the invention the mandrel is heated during spraying to a temperature providing limited softening of the polymer powder to help hold deposited powder in place and promote uniform coverage. Such heating is carefully limited so that the powder particles discharged from spray gun 16 remain below their softening temperature until they contact mandrel 10 or powder already on mandrel 10. To this end, mandrel 10 can be heated by warm air directed to the outside of the rotating mandrel, taking care not to allow the air flow to interfere with the sprayed powder trajectories, for example, by employing suitable shrouding or shielding.

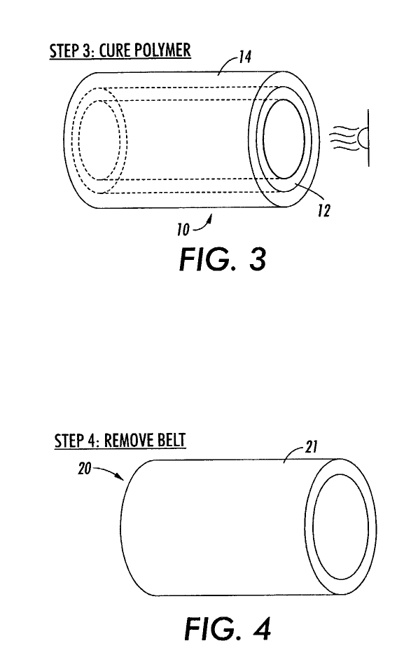

In Step 3, as illustrated in FIG. 3, mandrel 10 is removed from the powder booth and placed in an oven to sinter the powder coating on mandrel inner surface 12 and cure the polymer for a time and at a temperature selected according to the manufacturer's recommendations for the particular polymer employed. Such time and temperature will usually be readily determinable by those skilled in the art having regard to the directions herein and will usually be in the range of from 10 minutes to twenty-four hours, if desired, less than six hours, at a temperature in the range of from about 60° C. to about 600° C., if desired, from about 250° C. to about 450° C. For example, polyaryletheretherketone and other polymers may be cured for a time ranging from about 30 minutes to about 3 hours, if desired, about one hour, at a temperature in the range of from about 400 to about 425° C. (approximately 760 to 800° F.).

Oven curing is conducted under conditions such as to fuse the deposited powder material to form a uniform, continuous, seamless belt 18. However, the curing conditions should not be so stringent as to permit the material to flow causing deformities or irregularities in the product. To this end, one suitable temperature range is from the polymer's glass transition temperature to its melting point. The time may vary according to the loading in the oven as is known to those skilled in the art and can range, for example, from about 30 minutes to 6 hours. Rotation of the mandrel while curing may be employed, if desired, to improve uniformity.

In an alternative embodiment, if the thickness of the tube of polymeric material deposited in the mandrel has adequate integrity, it can be removed from the mandrel and placed in a curing oven. Optionally, thinner tubes, can be partially or fully cured, using radiant infrared energy or conductive or convective heat while on the mandrel, then removed from the mandrel and if necessary, secondary curing can be completed in an oven.

Optionally, if desired, the seamless belt, still mounted on mandrel 10, can be cooled in a two stage process comprising an initial, oven cooling step, to an intermediate temperature significantly below the polymer's glass transition temperature but well above room temperature, followed by an air cooling step to cool to a temperature at or close to room temperature.

The intermediate temperature may for example be in the range of about 65° C. to about 150° C. (about 150° F. to about 300° F.), if desired, or from about 80° C. to about 105° C., for example to about 93° C. (about 200° F.). Cooling the seamless belt in the oven while still on the mandrel can be a relatively slow process when conducted to avoid generation of deformities or non-uniformities in the belt which might be induced by more rapid cooling. The belt and mandrel are also easier to handle at the intermediate temperature than at the curing temperature.

When a suitable intermediate temperature is reached, the belt and mandrel are removed from the oven and rapidly air cooled to room temperature, employing fans or other forced air flow, if desired. This relatively more rapid air cooling step facilitates shrinkage of the belt and its separation from the mandrel.

In Step 4, as illustrated in FIG. 4, the formed seamless belt 20 can now readily be removed from mandrel 10 by hand, or alternatively, by machine or other suitable means. No special measures are required to pry seamless belt 20 loose from mandrel 10. Because the belt and mandrel materials have been selected so that the belt has a greater coefficient of thermal expansion than has the mandrel, and because seamless belt 20 adopts the inner dimensions of the mandrel at the elevated oven temperature as the belt material flows, upon cooling, seamless belt 20 contracts more than does mandrel 10, separating itself from the mandrel. Mandrel 10 can be reused to make additional seamless belts 20.

Following the practice of the invention can provide, after removal from mandrel 10, a seamless belt 20 which has a smooth regular outer surface 21 reflecting the quality of the inner surface of mandrel 10. The seamless belt outer surface 21 has few if any defects or irregularities and accurately conforms with the shape and, save possibly for minimal shrinkage on cooling, the dimensions, of inner surface 12 of mandrel 10, which shape can be a right circular cylinder or tube. Optionally, if a suitable polymer material is employed, formed seamless belt 20 may be essentially rigid. Another embodiment of the invention comprises a flexible product which can be conformed in use to cross-sectional shapes other than its relaxed state circular shape, for example an oval shape or the flattened shape a flexible belt customarily adopts when extended around and tensioned between a pair of rollers.

Seamless belt 20 also has good tensile strength and dimensional stability as well as relatively uniform thickness longitudinally and circumferentially and it is well suited for its intended uses. Suitable seamless belts 20 can have a center line circumferential thickness variation of not more than about 10 percent or, if desired, not more than about 5 percent for example not more than 1 percent. Furthermore seamless belts 20 can have highly uniform dimensional characteristics wherein the circumference thicknesses adjacent the ends or edges of the belt also meet the aforesaid thickness variation limits.

Pursuant to the present invention it is apparent that the process disclosed in McAneney et al. (supra) may provide direct control of the inside surface characteristics of the belt whose dimensions and inside surface quality are to some degree, if not largely, determined by the dimensions and finish of the outer surface of the mandrel or other substrate. Thus, McAneney et al.'s employment of a highly polished outer mandrel surface can promote formation of a seamless belt with a smooth inner surface helping removal of the belt from the mandrel after cooling but does not provide the definition and control of the outer surface of the seamless belt that are provided by the present invention.

Thus, the invention provides a process wherein a powder coating can be deposited on a highly polished, hollow mandrel form yielding a continuous seamless belt. The belt can have a high quality surface finish which may have a low average and low peak surface roughness, determined in part by the quality of the polished mandrel inner surface. Desirably, by selecting the mandrel and polymer materials so that the coefficient of thermal expansion of the mandrel is less than that of the polymer, during cooling, after curing, the polymer material will shrink away from the mandrel walls, facilitating release. By using a precision engineered, fixed diameter mandrel, the belt outside diameter and total circumference can be tightly controlled.

Employment of a powder as a coating medium in the process of the invention is environmentally desirable in that, with electrostatic guidance the polymer powder can be transferred to the mandrel with good efficiency. Moreover, oversprayed powders can be reclaimed from a spray booth by sweeping and/or vacuuming. In contrast, processes dependent on liquid spray or solution casting may disperse non-volatile liquid materials and lose volatiles to the atmosphere, which is environmentally undesirable and may require the complications of added controls of the manufacturing process to contain release of the volatiles. The electrostatic powder spraying deposition process of the invention can advantageously be performed without use of volatile organic polymer solvents or dispersion aids. It will however be understood that minor amounts of such volatile solvent may be employed for applying release coatings and for comparable purposes.

In the light of the present invention and its objects, the method of Miyamoto et al. (supra) can be seen to suffer from several drawbacks. For example, the use of volatile solvents which vaporize during processing, which are hard to contain and which are environmentally hazardous. This problem can be solved by the present invention by employing a solvent-free, dry powder spraying process as described herein.

Furthermore, Miyamoto et al. provides no teaching regarding removal of the belt from the mandrel. Pursuant to the present invention, it may be understood that, in some cases, heat curing of the polymer in contact with the metal casting drum at elevated temperatures, followed by cooling, may cause drum to shrink tightly onto the cooling film, resulting in separation difficulties, with possible loss of surface quality or dimensional control of the resultant seamless belt. The invention provides a solution to this problem by appropriate selection of the coefficients of thermal expansion of the mandrel and belt material, as described herein.

Thus, one or more embodiments of the invention described herein can provide a cost efficient method to produce seamless belts suitable for low or high volume production and which can be used to make belts in a range of sizes by using different mandrels, a relatively simple piece of equipment to provide as a range of components.

Furthermore, while the Agur et al. disclosure (supra) is believed suitable for its intended purpose, pursuant to the invention, it is possible to provide an alternative process of forming seamless belts which does not employ expansion of a preform into a mold by fluid pressure.

Seamless belts formed by the processes of the invention have many possible uses, as may be understood from the description of the invention herein and of the background art hereinabove, for example as drive belts in xerographic machinery. Also they are particularly suitable for use as fuser or toner belts in xerographic machinery for which purposes, additional material layers may be deposited on the structural substrate layer.

In an optional modified process, once seamless belt 20 has reached room or a suitably cool temperature, without removing seamless belt 20 from mandrel 10, the belt and mandrel can be returned to the powder spray booth and Steps 2 and 3 of the process can be repeated to provide an additional polymer layer on the inside of belt 20. For this purpose, seamless belt 20 should have sufficient adherence to mandrel 10 to allow the mandrel to be rotated and sprayed without significant displacement of the belt relative to the mandrel during processing. To assist adherence, if necessary, removable shims can be inserted between seamless belt 20 and mandrel 10. Oven time and temperature can be carefully controlled to fuse the new powder layer and minimize melting of the first layer. In this way a thicker seamless belt 20 can be built in two or more successive layers.

Additional Material Layers

Seamless belt 20 is a self-supporting, integral structure which can be subject to further processing and can support additional material layers providing one or more additional useful functions. For example, if the end product is a fuser or toner belt, the seamless belts 20 may constitute a structural substrate layer on which are deposited one or more additional material layers which may comprise a release layer, a conductive layer, a blocking layer, an adhesive layer, a photoconductive layer, a charge transport layer, or a combination of these or other layers known to those skilled in the art, with or without still further layers.

For example, fuser belts which fix an image by fusing toner on the surface of the belt, and toner belts which are used to transfer toner from one reservoir to another or one roll to another, require a release layer of a suitable material such for example as polytetrafluoroethylene (“PTFE” hereinafter). Such a release layer can be added by a process such as is described in the immediately following paragraphs, or elsewhere herein, or otherwise as is known to those skilled in the art or may be understood by those skilled in the art in the light of the disclosure herein.

Seamless belt 20, produced by the methods of the invention, is cleaned, if necessary, to remove release agent, for example with a suitable organic solvent, and is then employed as a substrate by tightly fitting the belt on the outer surface of a second mandrel (not shown).

The second mandrel (not shown) used to further process the belt is formed of a suitable structural material and can have any suitable configuration and construction that will hold belt 20 reasonably tightly, without slippage, during processing. For this purpose, the second mandrel may, for example, be radially or circumferentially spring-loaded to tension belt 20. One embodiment of second mandrel comprises a thin, resilient steel, longitudinally split sleeve of diameter slightly greater than the internal diameter of belt 20 that acts as a spring when compressed and inserted inside the belt. The second mandrel and belt can be mounted on a rotary table in a vertical position for application of additional materials.

In a subsequent step, a PTFE primer liquid spray is applied to the structural polymer belt substrate to facilitate adherence of the PTFE. A conductive or non-conductive primer layer may be applied depending upon the end use of the fully fabricated belt. Examples of suitable primers are, for a non-conductive coating, Dupont 855-021 and for a conductive coating Dupont 855-023. The primer is then air dried or flushed to remove surface solvent.

In a further step the PTFE coating is applied to the primed belt substrate as a liquid or powder. If a conductive primer layer was applied, a liquid PTFE coating can be used whereas for a non-conductive primer layer the coating may be a liquid or a powder.

The coated belt substrate is then placed in the oven for curing of the PTFE coating, optionally while still on the mandrel. Curing is effected at a temperature below the melting point of the structural belt material, for example, to just below that temperature at a temperature which poses little or no risk of the belt deforming as a result of viscous creep or other such temperature-related phenomenon yet which is as high as the material properties permit, so as to promote efficient curing. Employing a polyaryletheretherketone material having a melting point of about 340° C. (about 644° F.) the PTFE curing step can be effected at a temperature of about 315° C. (about 600° F.) plus or minus about 5-6° C. (about 9-10° F.).

Curing is effected to a sufficient degree to form a stable uniform solid layer, pursuant to the manufacturer's directions, for example for a period of from about 15 minutes to about 3 hours, for example about 1 hour.

After removal from the oven and cooling, which may be effected either in the oven or by air cooling outside the oven, the two layer belt is polished, for example by using a polishing wheel with the belt mounted on a mandrel and trimmed to size, if desired, for example by removing small sections from both ends of the belt. The resulting belt can be used as a fuser roll or toner transfer roll.

Alternatively, one or more circumferential cuts may be made to seamless belt 20 to subdivide it into multiple shorter belts, for example by supporting seamless belt 20 on the outside of a rotatable cutting support mandrel, rotating seamless belt 20 and cutting it with one or more rotary knives. Such a cutting support mandrel may have suitably placed circumferential grooves to accommodate the knife blades, if desired.

Other possible layers and methods for superimposing other layers on seamless belt 20 or on one or more additional layers supported on seamless belt 20 will be understood or be or become apparent to those skilled in the art in light of the disclosure herein including in particular disclosure regarding such other possible layers and methods in Agur et al. '091 and '762 and in other patents incorporated herein and also in light of developments in the art that may occur.

Mandrel Material

One suitable material for the mandrel is a stainless steel having a coefficient of linear thermal expansion of about 11.7×10⁻⁶ per ° C. (6.5×10⁻⁶ per ° F.), for example, stainless steel 301 (¾ hard).

Other materials, especially, but not exclusively, metals, can be employed for the mandrel provided that they meet the processing requirements described herein, are structurally stable at room and curing temperatures, can take an adequate interior polish according to the desired surface quality of the belt, can be separated from the seamless belt and can also have a coefficient of thermal expansion significantly lower than that of the belt material. Such materials desirably should not be chemically reactive, nor tarnish nor corrode during normal and repeated usage.

Some examples of alternative mandrel materials having relatively low coefficients of expansion are the metals nickel and chromium. Others will be known to those skilled in the art. For example, the following table illustrates the linear coefficients of thermal expansion of a number of metals commonly employed alone or in alloys:

Table of Coefficients of Thermal Expansion

| Linear Coeff. × 10⁻⁶ | per ° C. | per ° F. |
|---|---|---|
| Aluminum | 23.9 | 13.3 |
| Cobalt | 12.2 | 6.8 |
| Magnesium | 25.2 | 14 |
| Molybdenum | 5.4 | 3 |
| Nickel | 13.3 | 7.4 |
| Tantalum | 6.5 | 3.6 |
| Titanium | 8.5 | 4.7 |
| Vanadium | 7.7 | 4.3 |
| Zinc | 16.9+ | 9.4+ |

It may be understood from this table that metals having a linear coefficient of thermal expansion of less than about 15×10⁻⁶ per ° C., such as cobalt, molybdenum, nickel, tantalum, titanium and vanadium, and their alloys with comparable coefficients, are suitable for the purposes of the present invention. Metals such as aluminum, magnesium and zinc, having higher coefficients, are less suitable where a mandrel with a low linear coefficient of thermal expansion is desired.

Mandrels of bimetallic construction, employing coatings or platings of one material on another are contemplated as being less suitable for use with polymers requiring high temperature curing, such for example as PEEK™ polymer, because the temperature treatment may induce undesirable stresses in the mandrel arising from differences in expansion coefficients.

Other materials besides metals may be used, for example composite materials such as glass fiber or carbon fiber composites, provided that they have suitable coefficients of thermal expansion or provided that the seamless belt can be removed from the mandrel without requiring belt shrinkage. Pursuant to the invention, mandrel 10 can be homogeneously constructed with respect to any elements of the mandrel whose expansion or contraction may impact the process of the invention.

Belt-Forming Polymers

Suitable polymeric materials for use as the structural materials in the seamless belt manufacturing method of the invention are available as powdered materials that, when cured, provide sufficient tensile strength for the intended use of the belt and have a melting point which is sufficiently high to withstand possible finishing processes, if the belt is to be further processed after separation from the mandrel. One such finishing process comprises depositing an additional material layer on the belt pre-form, for example a release layer of polytetrafluoroethylene, “PTFE” hereinafter. The additional layer may be deposited as a powder and then cured in situ, in which case seamless belt 20, now a substrate for the new layer, needs to be able to withstand the new layer's curing temperature without loss of structural integrity.

These and other desirable polymer properties are further described below:

Tensile strength. If it is to be used as a carrier or drive belt, the seamless belt should be able withstand the tensile stresses and torque applied by rollers and the power source. The tensile strength of one suitable material, a polyaryletheretherketone available under the trademark PEEK from Victrex Plc, U. K. is about 14,000 psi which is adequate for such purposes.

Rheology Good flow capability at melting point is desirable to obtain uniform smooth films. The belt material can be selected as one which fuses quickly and forms a smooth film when its melting point is reached.

Electrostatic properties. Desirably, the polymer powder particles can accept and retain electrostatic charge in order to be applied electrostatically. PEEK™ polyaryletheretherketone has a dielectric strength of 190.

Melting point or melting range. The desirable melting point or melting range of some suitable polymers depends upon the intended application of the seamless belt. If the belt is to be coated with an additional layer of PTFE, for example for a fuser belt application, a melting point above 321° C. (610° F.) is desirable to permit curing of the PTFE over the belt. PEEK™ polyaryletheretherketone having a melting point of 340° C. (644° F.) is accordingly suitable for fuser belt applications.

For some applications, not subject to high temperature in use, for example toner transfer belts, a lower polymer melting temperature can be acceptable. In such cases, a low temperature cure modified PTFE coating can be employed as a release coating.

Continuous service temperatures. For applications requiring constant exposure to elevated temperatures, a polymer with a higher continuous service temperature rating is desirable. For example, the PEEK™ polyaryletheretherketone has a continuous service temperature of 260° C. (500° F.) which is suitable for 232° C. (450° F.) fusing applications.

Having regard to these considerations, some other polymer materials suitable for use in the method of the invention include thermosetting and thermoplastic polyimides available from, inter alia, DuPont, Honeywell, LNP, Mitsui Toatsu, and others. The invention can employ any suitable thermoplastic or thermosetting material that can be applied electrostatically and is capable of forming a durable flexible belt upon curing. Materials capable of withstanding fuser and PTFE cure temperatures can be used in fuser systems. Other materials can be used in low temperature belt applications.

Some suitable polymeric powder materials comprise imides and ketones. A specific suitable material is PEEK™ polyaryletheretherketone which is also advantageous for powder spraying by virtue of its low flammability. Low flammability is yet another desirable characteristic of polymers that are to be powder sprayed.

One group of suitable polymeric materials comprises materials having a coefficient of thermal expansion “a value” which is significantly higher than the coefficient of thermal expansion of the material from which the mandrel is formed to facilitate release of the cured belt from the mandrel. For example the polymeric powder material may have an a value of at least about 1.5 times the a value of the mandrel material, for example, at least about 2 times the a value of the mandrel material. From the point of view of the invention, there is no particular upper limit to the proportion, but there are of course physical limitations in the characteristics of materials. Also, a mandrel material with an excessively high coefficient of thermal expansion could lead to deleterious stressing of the mandrel with repeated use. A suitable polymer with a negative coefficient of thermal expansion would be attractive, were such to become available and to have otherwise satisfactory properties of tensile strength and the like, as described herein.

PEEK™ polyaryletheretherketone has an α value of about 39.6×10⁻⁶ per ° C. (about 22×10⁻⁶ per ° F.) which is more than three times greater than the coefficient of thermal expansion of the stainless steel referenced above. This differential in the thermal coefficients of expansion greatly facilitates removal of the cured belt form the mandrel as a result of thermal shrinkage. Thus polymer materials with high α values provided they are satisfactory in other respects are desirable for employment in the process of the invention.

Other polymeric materials that may be employed in the processes of the invention include any polymeric material suitable for the particular process of the present invention. Examples of suitable materials include polyethylene terephthalate (PET), polypropylene, polyvinyl chloride (PVC), polystyrene, polyacrylonitrile and polyacetals, as well as other orientable polymers such as polyamides, polyether ether ketone (PEEK), polyesters other than PET, and the like, as well as mixtures thereof. Other suitable polymers may be found in the references incorporated herein or will be known or apparent or will become known to those skilled in the art.

Where a polymer with a coefficient of thermal expansion greater than that of the mandrel material is desired, a reference can be made to the polymer supplier, or other suitable data sources for information as to the coefficients of different polymer materials, to facilitate the selection.

It is also a feature of the invention that the polymeric powder material may include, as discrete powder particles, or as ingredients of the polymeric powder, fillers or extenders, stabilizers, plasticizers, colorants and the like.

### EXAMPLE

The following, non-limiting example illustrates the practice of the invention to make a seamless belt formed using the particular material and having the dimensions set forth below. Other materials and dimensions and suitable variations in the parameters described below for making seamless belts having such other materials or dimensions will be apparent to those skilled in the art.

A silicone oil release coating is sprayed on the highly polished interior, roughness no greater than about 0.5 micron, of a hollow mandrel formed of stainless steel 301 (¾ hard) having a length of 508 mm (20 in), an internal diameter of 228.6 mm (9 in) and a wall thickness of 0.38 mm (0.015 in) is rotated at about 200 rpm. A Binks-Sames model MPG 2000 powder gun provided with a 60 cm (24 inch) long extension nozzle (Binks-Sames part #62-5520-04) is operated to deliver 2.9 gm/sec of PEEK™ polymer. An electrical field of 40 kV is applied between the powder gun and the mandrel and the powder gun is reciprocated at a speed of 18 mm/sec (0.7 in/sec) with a cycle time of 48 seconds in a single pass.

The resulting polymer layer is cured on the mandrel at about 405° C. (760° F.) for approximately 30 minutes. Power to the oven is shut off and the mandrel and seamless belt are cooled to about 93° C. (about 200° F.) while still in the oven then air cooled to about room temperature. The resulting belt is readily removed from the mandrel by hand and is trimmed to a length of 457 mm (18 in). The belt has an outside diameter of 227.1 mm (8.940 in) with a variance of +/−0.25 mm (+/−0.010 in) as measured along the belt and a belt thickness of 0.1 mm (0.004 in) with a variance of +/−0.005 mm (+/−0.0002) in as measured around the center diameter.

The belt has a surface roughness of 1-1.4 micron, an average tensile strength of 11,000 psi, a surface energy (contact angle) of 100 degrees with water (after the belt has been coated with polytetrafluoroethylene) and a specular gloss of 8 to 10 (using a 60 degree angle gloss meter).

It will be understood that the method and apparatus of the invention can be used to manufacture seamless belts having dimensions lying within wide ranges of variation. Some such ranges are: a length of from about 50 mm to about 2 meters, for example a range of from about 100 mm to about 1 meter; a diameter of from about 25 mm to about 1 meter, for example a range of from about 75 mm to about 500 mm, and a thickness of from about 0.02 mm to about 100 mm, for example a range of from about 0.5 mm to about 5 mm. Powder spraying, as described herein is useful, inter alia, for manufacturing thin belts, for example belts having thicknesses less than about 2 mm or less than about 1 mm. Other possible dimensions will be apparent to those skilled in the art.

Embodiments of Powder Spraying Apparatus

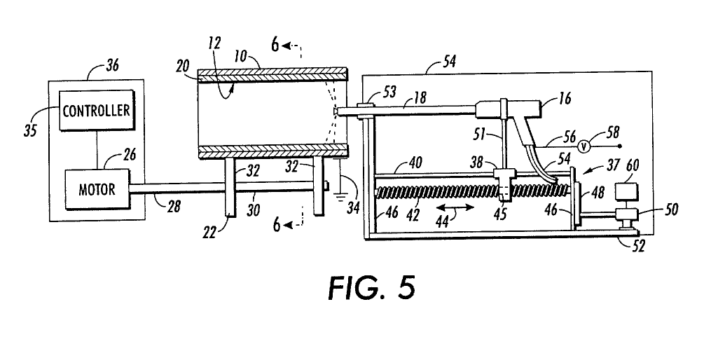

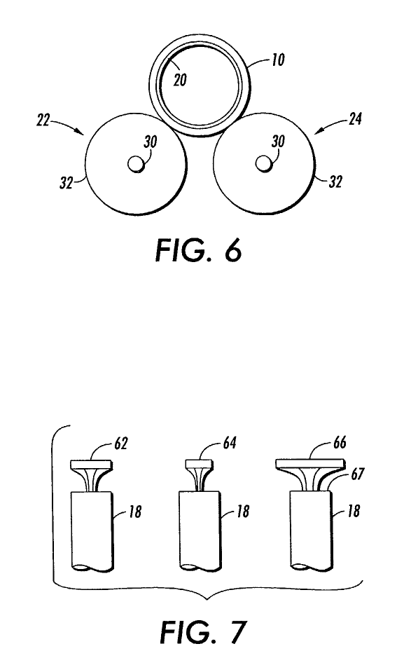

Referring now to FIGS. 5-6, in the embodiment of inventive belt-forming apparatus shown, mandrel 10 is supported on a pair of horizontally side-by-side roll rotators 22, 24 (FIG. 6) for rotation by a motor 26, via a drive shaft 28 coupled to rotator 22. Rotators 22, 24 can be mounted in bearings and supported by any suitable frame, stand, table or the like suitably juxtaposed to spray gun 16. This routine structure is not shown in the drawings.

Roll rotator 24 is an idler rotator serving to support but not drive mandrel 10. Each rotator 22, 24 comprises a shaft 30 carrying two, or optionally, more, rollers 32 of any suitable construction to support and drive mandrel 10. In one suitable construction, rollers 32 comprise aluminum disks circumferentially lined with rubber for good frictional engagement with mandrel 10 to enable rollers 32 to rotate and position mandrel 10 without slippage.

Mandrel rotation is desirable to promote uniformity of the thickness of the seamless belt being manufactured, especially in the circumferential direction. Other suitable mandrel rotator devices may be employed, as will be known to those skilled in the art, and some suitable alternative rotator structures are described below. The mandrel rotator or mandrel rotator means can be operative to rotate the mandrel from the outside, leaving the entire inner volume of the mandrel, as that volume is defined by the inner surface on which powder is to be deposited, free and clear of rotary or other structure. The purpose of this clear volume is to accommodate reciprocation of spray gun nozzle 18 within the mandrel without interfering with the travel of powder from spray gun nozzle 18 to mandrel inner surface 12. To this end, spray gun nozzle 18 can be somewhat longer than mandrel 10, for example twenty-five percent longer.

Mandrel 10 can be electrically grounded, and a suitable high voltage applied to spray gun 16 to create an electrical field between mandrel 10 and spray gun 16 to guide powder from the gun to the mandrel surface. Grounding may be done by any suitable means, for example by an electrically conductive, resilient leaf spring 34 engaging the outer surface of mandrel 10.

A controller 35, which can be computerized or can be coupled to a computer, if desired, can be provided to control the speed and duration of the rotation of motor 26 and thence of mandrel 10. Another option is for motor 26 and controller 35 to be enclosed in a dust chamber 36 to minimize exposure of this sensitive equipment to polymer dust generated during spraying.

Spray gun 16 can comprise any suitable commercially available product, for example, a Binks-Sames model MPG 2000 powder gun provided with a 60 cm (24 inch) long extension nozzle (Binks-Sames part #62-5520-04) which can be employed with a Binks-Sames model GCM 2000 powder gun control module, if desired.

Spray gun 16 is mounted for reciprocal movement back and forth along the axis of rotation of mandrel 10 by a reciprocator indicated generally at 37.

Reciprocator 37 comprises a traveling platen 38 supported for sliding movement on a pair of rails 40 (one shown) and driven back and forth by screw shaft 42, as indicated by the double-headed arrow 44. Platen 38 has a threaded hole 45 which matingly engages threaded shaft 42. Side rails 40 and threaded shaft 42 are supported by stanchions 46. Threaded shaft 42 is driven via a suitable belt, or gear, transmission 48 by reversible motor 50.

Depending upon the flammability and spark sensitivity of the powder sprayed, motors 24 and 50 can be powered by electricity or compressed air. Since electricity is more convenient a low flammability and spark-insensitive polymer powder is desirable, such for example as PEEK™ polymer.

Reciprocator 37 can be custom designed or may be any suitable commercially available horizontal gun reciprocator, for example such as are available from Wagner Systems Inc., Carol Stream, Ill., Integrated Drive Systems Pvt. Ltd, Mumbai, India, Binks-Sames, The DeVilBiss Company, Deco Tools, Inc. and other sources.

Spray gun 16 is supported on platen 38 for travel therewith by any suitable structure such as post 51. The various components of reciprocator 37 can be mounted on any suitable base 52. If desired, reciprocator 37 and spray gun 16 can be enclosed in a dust booth 54 from which nozzle 18 projects. Nozzle 18 can be supported for sliding movement, optionally wit h a dust seal (not shown), by a sleeve 53 secured to lefthand stanchion 46. Post 51 and sleeve 53 serve to align spray gun 16 for reciprocal movement along the axis of rotation of mandrel 10, or other desired path parallel to that axis. Other suitable mounting and alignment structure for spray gun 16 will be apparent to those skilled in the art. Accurate alignment on a parallel path with the rotational axis of mandrel 10, throughout the longitudinal extent of seamless belt 20 is desirable for uniformity of thickness of seamless belt 20 along its length.

A pair of hoses 54 extends from spray gun 16 to supply compressed air and polymer powder to spray gun 16 for generation of a powder stream. A conductor 56 supplies a suitable electrostatic voltage from voltage source 58 to suitable conductive structure on or associated with spray gun 16, for example to a conductive lining (not shown) of the interior of nozzle 18 where it can be applied to powder traveling through the nozzle. Motor 50 can be operated by a controller 60 to control the speed and timing of the reciprocal movement of platen 38. Controllers 35 and 60 can be coordinated to synchronize operation of the spray gun 416 with rotation of mandrel 10 by any suitable structure, for example by computerized means e.g. a personal computer. The motions of spray gun 16, and the powder stream discharging therefrom can be carefully controlled to provide a uniform coating of powder on the inside of mandrel 10, for example by maintaining a constant velocity and constant discharge rate, or by adjusting the travel of spray gun 16 to compensate for variations in the velocity or discharge rate. Motor 24 can also controlled to maintain a constant angular velocity during powder spraying.

As shown in FIG. 7, spray gun nozzle 18 can be provided with a selected one of a range of different deflectors, three examples of which are shown at 62, 64 and 66. Deflectors such as deflectors 62, 64 and 66 have different sizes and configurations according to the dimensions of mandrel 10 and the seamless belt being manufactured. In general, larger diameter deflectors such as deflector 66, with a greater spread transversely to the direction of flow of the powder stream emerging from nozzle 18, and extending laterally beyond the outer sidewall of the end 67 of nozzle 18, will provide greater lateral projection of the powder. Thus, deflector 66 is more appropriate for wider mandrels 10 and large diameter seamless belts 20. Selection of an appropriate deflector 62, 64 or 66, if employed, can usually be assisted by the spray gun manufacturer's instructions.

Deflector 62 is the smallest of the three shown, having an extent less than the width of nozzle 18, while deflector 64 is of intermediate size. If desired, and if so indicated by the manufacturer, the longitudinal projection of the deflector 62, 64 or 66 from nozzle 18 can be varied to control the rate of discharge of the spray powder.

The belt-forming apparatus illustrated in FIGS. 5-7 can be operated to carry out the powder spray application step, Step 2, of the seamless belt manufacturing method described above in connection with FIGS. 1-4.

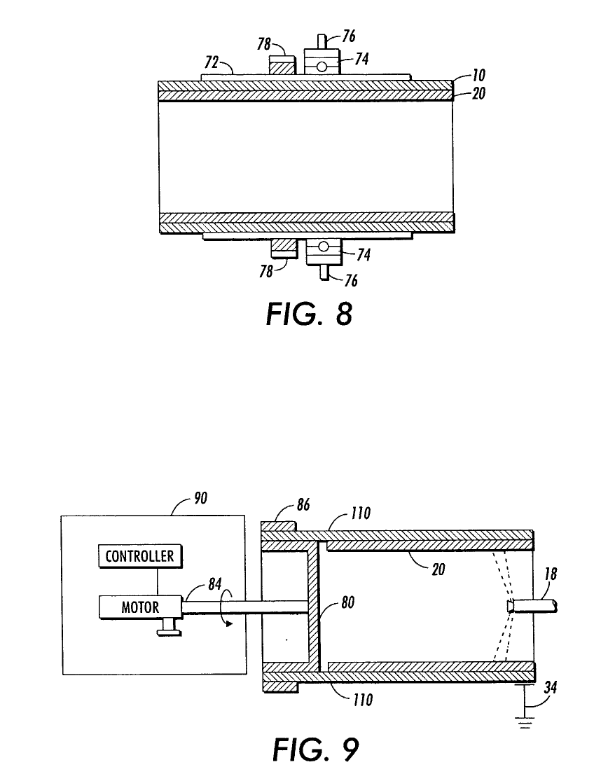

An alternative arrangement for supporting and driving mandrel 10 is illustrated in FIG. 8. Referring to FIG. 8, mandrel 10 shown with material for seamless belt 20 deposited inside the mandrel, is supported in an external sleeve 72 which can extend for a major portion of the length of mandrel 10, if desired or may be relatively short compared with the mandrel length. As can be seen in FIG. 8, sleeve 72 can accommodate mandrels having different lengths. Sleeve 72 is rotatably mounted in at least one bearing 74 and supported by any suitable support 76. Optionally, two bearings 74 can be employed spaced apart along the axis of mandrel 10 to avoid tilting the mandrel axis during rotation. Mandrel 10 with supportive sleeve 72 can be rotated by any suitable structure, for example a pinion drive to a ring gear 78 alongside bearing 74. The mandrel support structure shown in FIG. 8 can also support mandrel 10 with a free and clear internal space to accommodate powder spraying and securely locates mandrel 10 against axial displacement during rotation.

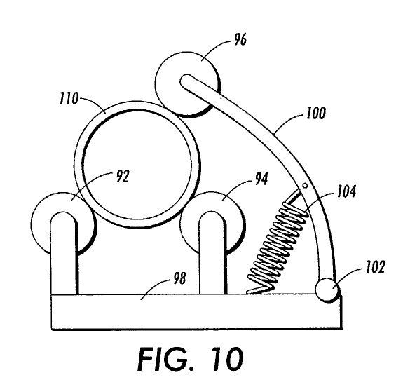

A further mandrel support and drive arrangement is illustrated in FIGS. 9 and 10. Referring to FIG. 9, a modified mandrel 110 is shown internally supported at a closed end, the lefthand end as shown in FIG. 9. The righthand end of mandrel 110 is open to provide access for nozzle 18 of powder spray gun 16. In this embodiment, mandrel 110 extends substantially beyond seamless belt 20 so that not all the inner surface of the mandrel receives powder deposits. If the lefthand end portion is less uniform than desired an over-size seamless belt 20 can be made and the left hand end can be trimmed off.

As shown, mandrel 110 is supported on an arbor 80 for rotation by a motor 82 via a shaft 84. Hollow mandrel 110 can be secured to arbor 80 by any desired securing means, for example a ring clamp 86. A controller 88 which may also be computerized or may be coupled to a computer, can be provided to control the speed and duration of the rotation of mandrel 110. If desired, motor 82 and controller 88 can be enclosed in a dust chamber 90 to minimize exposure of this sensitive equipment to polymer dust generated during spraying. Mandrel 110 can also be grounded by a suitable contact, such as leaf spring 34, for electrostatic spraying.

Depending upon the proportions, rigidity and other structural characteristics of mandrel 110, guide structure can be provided to help maintain mandrel 110 in proper alignment, relative to the travel of spray gun 16, as it rotates. One such guide structure or supplementary support system is shown in FIG. 10 and comprises three cylindrical and axially mounted rotating rollers 92, 94 and 96 engaging the outer surface of mandrel 10. The two lower rollers 92-94 in the figure are mounted on a fixed support arm 98 while the upper roller 96 is mounted on a pivotable arm 100 which is connected to arm 98 by pivot 102. A tension spring 104 urges arm 100 towards arm 98. Arm 100 is pivoted to mount and dismount mandrel 110 while rollers 92-96 support and radially locate mandrel 110 for rotation. Other means of supporting and aligning mandrel 10, as it rotates, will be known or apparent to those skilled in the art and may be employed in the practice of the present invention.

The mandrel support structure shown in FIG. 9, optionally employed with a guide arrangement and supplementary support system such as that shown in FIG. 10 provides an alternative means for supporting mandrel 10 with a free and clear internal space to accommodate powder spraying. Also, mandrel 10 is securely located against axial displacement during rotation by arbor 80 and clamp 86.

Furthermore, other suitable mandrel support structure that provide or can accommodate a rotational drive while leaving the mandrel interior free and clear for powder spraying may be employed in the invention, as will be known, or become known, to those skilled in the art.

In accordance with an alternative embodiment of the invention, the mandrel may comprise two or more axially extending and circumferentially separable sections (not shown) secured together by bolts, clamps or the like that can be taken apart for belt removal. If the section boundaries introduce discontinuities, or mold lines, into the outer, smooth surface of the seamless belt such mold lines could be removed by machining and polishing, if desired, to provide a belt of controlled outer surface quality and dimensions essentially conforming to the mold provided by the inner mandrel surface. Optionally, the mandrel can include removable plugs enabling compressed air or other fluid to be applied to the seamless belt in the mandrel to facilitate removal of the belt from the mandrel.

Such a split mandrel construction can be employed to permit electrostatic powder spray application to the inner surface of a hollow mandrel of polymers having coefficients of thermal expansion that are not sufficiently greater than that of the mandrel material to permit satisfactory belt removal, even with the use of release agents, which agents are further described hereinbelow. Thus, the benefits of electrostatic powder spray application and good outer surface definition and dimensioning may be obtained with such other polymer materials.

Such split mandrel sections could be combined with an inner sleeve or liner of one-piece unitary construction to maintain the seamlessness of the belt outer surface. Alternatively, mandrel 10 could comprise multiple cylindrical layers, the innermost of which is continuous and uninterrupted.

Automation

The above-described inventive apparatus can be automated for volume production of seamless belts in a number of different ways. For example, multiple spray guns can be moved longitudinally of multiple mandrels, being operated in a gang by a single reciprocator to powder spray, form or add layers to a number, e.g. from 2 to 12, of seamless belts at one time. Reciprocators suitable for such purposes are provided by various of the suppliers referenced hereinabove.

Also, automated handling equipment can be provided, if desired, to prepare the mandrel or mandrels, move the mandrels and belts through the curing and cooling cycles and to remove the belt or belts from the mandrel or mandrels. Automated supervisory equipment can also be provided, if desired to monitor and control these and other operations, employing suitable sensors and computer equipment.

Other Material Deposition Processes

While particular embodiments of the invention have been largely described, as employing electrostatic or other powder spraying means to deposit a polymer film or coating on a mold, it will be understood that the invention, also provides a novel combination of mandrel and polymer materials intended for use in a belt-forming process employing a hollow mandrel or a drum, and which materials have coefficients of thermal expansion that are selected to facilitate removal of the formed belt from a mold such as inner mandrel surface 12. Thus, this latter aspect of the invention can be beneficially employed in other suitable material deposition processes, for example in methods employing expansion of a preform into a mold by fluid pressure as taught by Agur et al. (supra) or in methods employing solution casting into a drum as taught by Miyamoto et al. (supra), followed by curing and cooling.

Furthermore, while a desirable product of the inventive process is a seamless belt having a smooth outer surface, as described herein, it will be understood that by suitably varying the topography of inner surface 12 of mandrel 10 seamless belts with other surface characteristics, for example a roughened, textured, contoured or regularly patterned surface can be provided, if desired.

Also, while the invention has been described in the context of spray deposition of polymer powders that are subsequently cured to form a coherent article, it will be understood that other powdered materials could be employed with similar results. For example, a powdered metal could be sprayed and sintered employing suitable powdered sintering agents or adhesives, if desired. A ceramic mandrel could be employed if necessary to withstand high sintering temperatures.

The entire disclosure of each patent and patent application cross-referenced or referenced herein and of any non-patent publication referenced herein is hereby incorporated herein by reference thereto, as though fully set out herein. Each document incorporated by reference in any of the foregoing patents, patent applications or non-patent publications is also fully incorporated herein. In addition, where reference is made herein to a patent, a patent application or to a non-patent publication, while describing the invention, the material portion or portions of that patent, patent application or non-patent publication, as determined by the context of the reference, are also hereby incorporated herein by such reference thereto in context with the referencing disclosure.

While illustrative embodiments of the invention have been described above, it is, of course, understood that various modifications will be apparent to those of ordinary skill in the relevant art, or may become apparent as the art develops. Many such modifications are contemplated as being within the spirit and scope of the invention.

It is, therefore, evident that there has been provided, in accordance with the present invention, a seamless belt manufacture method, apparatus and product that fully satisfies the aims and advantages hereinbefore set forth. While this invention has been described in conjunction with some embodiments thereof, it is evident that many alternatives, modifications and variations will be apparent to those skilled in the art. Accordingly, it is intended to embrace all such alternatives, modifications and variations as they fall within the spirit and broad scope of the appended claims.

What is claimed is:

1. A process for manufacturing an endless seamless belt from a polymeric material, the process comprising:
a) spraying a fusible polymeric powder from a powder source onto the inner surface of a hollow mandrel, the mandrel inner surface providing a cylindrical form for the seamless belt and the form being covered with sprayed powder;
b) curing the powder deposited on the mandrel at an elevated temperature to fuse the powder and form the seamless belt; and
c) removing the seamless belt from the mandrel.

2. A process according to claim 1 wherein powder spraying is conducted electrostatically by employing a polymeric powder suitable for electrostatic spraying and by generating an electrical field, optionally of from about 30,000 to about 50,000 volts, between the powder source and the mandrel form to guide the sprayed powder from the mandrel source to the mandrel form.

3. A process according to claim 2 comprising cooling the mandrel and seamless belt after curing and before removing the seamless belt from the mandrel wherein the mandrel is formed of a material selected to have a first coefficient of thermal expansion and the polymer is selected to have a second coefficient of thermal expansion, the second coefficient of thermal expansion being greater than the first coefficient of thermal expansion, optionally at least two times greater, to permit the seamless belt to shrink from the mandrel during cooling to facilitate removal of the belt from the mandrel.

4. A process according to claim 3 wherein the mandrel comprises a thin sleeve, optionally having a wall thickness of not more than about 3 mm and is homogeneously constructed from stainless steel, chromium or nickel.

5. A process according to claim 2 comprising cooling the mandrel and seamless belt after curing and before removing the seamless belt from the mandrel wherein the polymer material has a coefficient of thermal expansion at least 1.5 times greater, optionally, at least three time greater than the coefficient of thermal expansion of the mandrel material.

6. A process according to claim 3 wherein the polymer comprises a thermosetting or thermoplastic polyimide, optionally a polyaryletheretherketone.

7. A process according to claim 3 wherein the form-defining mandrel inner surface is polished to facilitate removal of the seamless belt from the mandrel, optionally to a surface roughness of no more than one micron.

8. A process according to claim 7 the process further comprising applying a release coating to the mandrel inner surface form before spraying powder onto the mandrel inner surface form.

9. A process according to claim 3 comprising rotating the mandrel throughout the spraying of polymeric powder, optionally at from about 20 to about 500 rpm.

10. A process according to claim 3 wherein the powder source comprises a spray gun having a nozzle to discharge the sprayed powder and the method comprises moving the spray gun nozzle, relatively to the mandrel, reciprocally along the axis of the mandrel form cylinder, optionally with the nozzle traveling within the mandrel substantially throughout the extent of nozzle movement.

11. A process according to claim 3 wherein curing is effected by heating the polymer for a time and at a temperature selected according to the manufacturer's recommendations for the particular polymer employed, optionally being a temperature in the range of from the polymer's glass transition temperature to about the melting point of the polymer, so as to fuse the deposited powder material to form a uniform, continuous, seamless belt.

12. A process according to claim 3 comprising cooling the mandrel in a first relatively slow cooling stage to an intermediate temperature, optionally about 65° C. to about 150° C. followed by cooling in a second, relatively rapid cooling stage to about room temperature.

13. A process according to claim 3 comprising employing dust-containment structures to control the release of polymer dust particles to the environment.

14. A process according to claim 2 comprising cooling the mandrel and seamless belt after curing and before removing the seamless belt from the mandrel wherein the mandrel is formed of a non-corrodible metal, the polymer comprises a thermosetting or thermoplastic polyimide having a coefficient of thermal expansion at least 1.5 times greater than the coefficient of thermal expansion of the mandrel material, the form-defining mandrel inner surface is polished to facilitate removal of the seamless belt from the mandrel and the mandrel is rotated throughout the spraying of polymeric powder.

15. A process according to claim 1 wherein the mandrel comprises a thin sleeve having a wall thickness of not more than about 3 mm, is homogeneously constructed from stainless steel, chromium or nickel, the form-defining mandrel inner surface is polished to a surface roughness of no more than about one micron and the mandrel is rotated throughout the spraying of polymeric powder optionally at from about 20 to about 500 rpm, the polymer comprises a polyaryletheretherketone, wherein the powder source comprises a spray gun having a nozzle to discharge the sprayed powder, powder spraying is conducted electrostatically by generating an electrical field of from about 30,000 to about 50,000 volts between the spray gun and the mandrel form to guide the sprayed powder from the mandrel source to the mandrel form and wherein the method comprises:
d) moving the spray gun nozzle reciprocally along the axis of the mandrel form cylinder and within the mandrel;
e) effecting curing by heating the polymer at a temperature of from about 400 to about 425° C. for from about 30 minutes to about 3 hours;
e) cooling the mandrel and seamless belt after curing and before removing the seamless belt from the mandrel in a first cooling stage to an intermediate temperature of from about 65° C. to about 150° C. followed by cooling in a second cooling stage to about room temperature; and
f) employing dust-containment structures to control the release of polymer dust particles to the environment.

16. A process for manufacturing an endless seamless belt from a polymeric material, the process employing a hollow mandrel having an inner surface providing a form for the seamless belt, the form optionally being cylindrical, wherein the polymer material has a coefficient of thermal expansion selected to be greater than the coefficient of thermal expansion of the mandrel material to permit the seamless belt to shrink from the mandrel during cooling, and the process comprises:
a) depositing a heat curable polymer material in a flowable state onto the inner surface of the hollow mandrel to cover the form with polymer material;
b) curing the deposited polymer on the mandrel at an elevated temperature to form the seamless belt;
c) cooling the mandrel and seamless belt after curing and before removing the seamless belt from the mandrel; and
d) removing the seamless belt from the mandrel.

17. A process according to claim 16 wherein the coefficient of thermal expansion of the polymer material is at least 1.5 times greater, optionally, at least three time greater than the coefficient of thermal expansion of the mandrel material.

18. A process according to claim 17 wherein the polymeric material comprises a polyimide and the mandrel material comprises stainless steel, chromium or nickel the method comprising cooling the mandrel in a first relatively slow cooling stage to an intermediate temperature, optionally about 65° C. to about 150° C. followed by cooling in a second, relatively rapid cooling stage to a lower temperature, optionally about room temperature.

19. An endless, seamless belt manufactured by a process according to claim 1.

20. Apparatus for manufacturing an endless seamless belt from a fusible polymeric material, the apparatus comprising:
a) a hollow mandrel having an inner surface providing a cylindrical form for the seamless belt, the mandrel being rotatable about an axis; and
b) a powder spray gun reciprocally movable relatively to the hollow mandrel in the direction of the mandrel axis for spraying the polymeric powder onto the inner surface of the hollow mandrel.

21. Apparatus according to claim 20 comprising a voltage source operable to generate an electrical field, optionally of from about 30,000 to about 50,000 volts, between the powder source and the mandrel form to guide the sprayed powder from the mandrel source to the mandrel form.

22. Apparatus according to claim 20 wherein the mandrel is formed of a material selected to have a first coefficient of thermal expansion and the polymer is selected to have a second coefficient of thermal expansion, the second coefficient of thermal expansion being greater than the first coefficient of thermal expansion, optionally at least two times greater.

23. Apparatus according to claim 20 wherein the mandrel comprises a thin sleeve, optionally having a wall thickness of not more than about 3 mm and is homogeneously constructed from stainless steel, chromium or nickel.

24. Apparatus according to claim 20 wherein the form-defining mandrel inner surface is polished to facilitate removal of the seamless belt from the mandrel, optionally to a surface roughness of no more than one micron.

25. Apparatus according to claim 20 wherein the mandrel is supported for rotation, optionally at a speed in the range of from about 20 to about 500 rpm, by a pair of roll rotators having peripheral rotating surfaces engaging and supporting the outer surface of the mandrel.
